(19) United States
(12) Patent Application Publication
(10) Pub. No.: US 2026/0141174 A1
(43) Pub. Date: May 21, 2026

(54) ENGLISH SPELLING CORRECTION METHOD

(71) Applicant: ADVANCED VIEW INC., Taipei (TW)

(72) Inventor: CHUNG-HSING CHEN, Taipei (TW)

(21) Appl. No.: 19/339,015

(22) Filed: Sep. 24, 2025

(30) Foreign Application Priority Data
Nov. 21, 2024 (TW) 113144889

(51) Int. Cl. G06F 40/232; G06N 3/0464

(52) U.S. Cl. CPC G06F 40/232; G06N 3/0464

(57) ABSTRACT

An English spelling correction method encoding each English character of each input English word string and normalizing a corresponding encoding number to obtain an initial numbering array numeric, performing distance calculation and normalization on the encoding number to obtain an initial distance array numeric, using a number (n) of English characters in an input English word string to generate a feature map with a variable length, performing a one-dimensional convolutional neural network operation and a fully-connected layer on the feature map to generate a feature map, outputting the feature map by a bidirectional long short-term memory (LSTM) network and performing a fully-connected layer to generate a feature map, performing a probability recognition and outputting a probabilistic word string, recognizing the probabilistic word string and outputting an English spelling correction result.

### BACKGROUND OF THE INVENTION

### Field of Invention

The invention relates to an English correction method, more particularly to an English spelling correction method that utilizes character sequence relationship, character distance and variable array length to accurately correct English spellings.

### Related Art

Most of the current English word spelling correction systems use binary tree tracking or dictionary sequence comparison, and subsequently use RNN (recursive neural network) for sequence prediction.

Both binary tree and dictionary sequence comparison will encounter a problem, which is that the binary tree and dictionary sequence may have missing or extra characters in the input word string for spelling check. The missing or extra character problem occurs mainly because the image pre-processing is not perfectly done in the recognition stage, which causes fragmentation during binary segmentation, so there will be a problem of pattern disappearance. When the problem of pattern disappearance occurs, the binary tree and dictionary sequence comparison method cannot effectively correct English spelling.

During use, recursive neural network can only remember the order in which training characters are arranged, but it may not able to accurately predict the corrected word for misspelled characters. This can lead to inaccurate predictions. For example, Republic of China Patent Publication No. I846578 primarily utilizes a fixed array length for training and operational analysis. However, during operational processing primarily using a fixed-length array, mismatch between the array length and the word length can occur easily, which will cause the recursive neural network to have problems with missing or extra characters, so the predicted results may not be correct.

Therefore, the inventor of the invention and relevant manufacturers engaged in this industry are eager to research and make improvement to solve the above-mentioned problems and drawbacks in the prior art.

### SUMMARY OF THE INVENTION

Therefore, in order to effectively solve the above-mentioned problems, a main object of the invention is to provide an English spelling correction method that utilizes character sequence relationship, character distance and variable array length to accurately correct English spellings.

In order to achieve the above-mentioned object, the invention provides an English spelling correction method, which is applied to an electronic device with computing capabilities, the electronic device comprises an AI processing unit, the English spelling correction method at least comprising: serializing English characters and obtaining a plurality of encoding numbers; receiving an input English word string composed of a plurality of English characters and obtaining a number (n) of the English characters; normalizing the encoding numbers corresponding to each of the English characters of the input English word string and obtaining a plurality of initial numbering array numerics; performing Euclidean distance calculation on the encoding numbers corresponding to the adjacent English characters of the input English word string and obtaining a plurality of Euclidean distance values, and normalizing each of the Euclidean distance values and obtaining a plurality of initial distance array numerics; obtaining a number (n) of the English characters of the input English word string and arranging in sequence according to the initial numbering array numerics and the initial distance array numerics corresponding to each of the English characters of the input English word string and generating a first feature map of 1×(2×n) in a first layer; performing a one-dimensional convolution operation of convolutional neural network on the first feature map and generating 6 second feature maps with an array of 1×(2×n+2−3+1) in a second layer; performing a one-dimensional convolution operation of convolutional neural network on the second feature map and generating 16 third feature maps with an array of 1×((2×n+2−3+1)+2−3+1) in a third layer; performing a fully-connected layer of convolutional neural network on the third feature map and forming a fourth feature map with an array of (2×n)×16 in a fourth layer; performing a fully-connected layer of convolutional neural network on the fourth feature map, and converting into a fifth feature map of ((2×n)/4)×64 compatible with inputting into a bidirectional long short-term memory (LSTM) network in a fifth layer; performing a bidirectional long short-term memory (LSTM) network operation on the fifth feature map and outputting a sixth feature map with an array of ((2×n)/4)×128 in a sixth layer; performing a bidirectional long short-term memory (LSTM) network operation on the sixth feature map and outputting a seventh feature map with an array of ((2×n)/4)×128 in a seventh layer; performing a fully-connected layer on the seventh feature map and forming an eighth feature map with an array of 37×(2×n) in an eighth layer; performing a probability recognition according to the eighth feature map with an array of 37×(2×n) and outputting a probabilistic word string with a character length of (2×n); and recognizing the probabilistic word string according to a search setting to output an English spelling correction result.

The invention further discloses an English spelling correction method, wherein the AI processing unit serializes the English characters and unit digits and obtains the encoding numbers, and wherein the AI processing unit serializes the English characters from A to Z and the unit digits from 0 to 9 and obtains the encoding numbers of each of the English characters and the unit digits.

The invention further discloses an English spelling correction method, wherein in the step of the AI processing unit normalizing the encoding numbers corresponding to each of the English characters of the input English word string and obtaining the initial numbering array numerics, the normalization is to divide each of the encoding numbers by 36 to obtain the initial numbering array numerics.

The invention further discloses an English spelling correction method, wherein in the step of the AI processing unit performing Euclidean distance calculation on the encoding numbers corresponding to the adjacent English characters of the input English word string and obtaining a plurality of Euclidean distance values, and normalizing each of the Euclidean distance values and obtaining a plurality of initial distance array numerics, the normalization is to divide each of the Euclidean distance values by 36 to obtain the initial numbering array numerics.

The invention further discloses an English spelling correction method, wherein a formula of the Euclidean distance value is d(X₁,X₂)=\sqrt{(X₁−X₂)²}.

The invention further discloses an English spelling correction method, wherein the AI processing unit performs 6 one-dimensional convolution operations of convolutional neural network with a kernel of random values and a 1×3 array to generate the 6 second feature maps with an array of 1×(2×n+2−3+1) in the second layer.

The invention further discloses an English spelling correction method, wherein the AI processing unit performs 16 one-dimensional convolution operations of convolutional neural network with a kernel of random values and a 1×3 array to generate the 16 third feature maps with an array of 1×((2×n+2−3+1)+2−3+1) in the third layer.

The invention further discloses an English spelling correction method, wherein when the first feature map is performed with the one-dimensional convolution operation of convolutional neural network, a blank feature is added at a beginning and an end of the array respectively to form the second feature map of 1×(2×n+2−3+1), and when the second feature map is performed with the one-dimensional convolution operation of convolutional neural network, a blank feature is added at a beginning and an end of the array respectively to form the third feature map of 1×((2×n+2−3+1)+2−3+1).

The invention further discloses an English spelling correction method, wherein the search setting comprises a blank character setting and a repeated character setting, and the AI processing unit recognizes the probabilistic word string, and removes the blank character setting and the repeated character setting to output an English word string recognition result.

### BRIEF DESCRIPTION OF THE DRAWINGS

FIG. 1A is a partial flow chart 1 of an English spelling correction method of the invention.

FIG. 1B is a partial flow chart 2 of the English spelling correction method of the invention.

FIG. 2 is a schematic diagram of hardware architecture of an electronic device of the invention.

FIG. 3 is a schematic diagram of a table of serial codes of the invention.

FIG. 4 is a schematic diagram of a flow chart of the English spelling correction method of the invention.

FIG. 5 is a schematic diagram of a probability vector table of the invention.

### DETAILED DESCRIPTION OF THE INVENTION

The above objects of the invention, as well as its structural and functional features, will be described in accordance with the preferred embodiments of the accompanying drawings.

In the following, for the formation and technical content related to an English spelling correction method of the invention, various applicable examples are exemplified and explained in detail with reference to the accompanying drawings; however, the invention is of course not limited to the enumerated embodiments, drawings, or detailed descriptions.

Furthermore, those who are familiar with this technology should further understand that the enumerated embodiments and accompanying drawings are only for reference and explanation, and are not used to limit the invention; other modifications or alterations that can be easily implemented based on the detailed descriptions of the invention are further deemed to be within the scope without departing from the spirit or intention thereof as defined by the appended claims and their legal equivalents.

And, the directional terms mentioned in the following embodiments, for example: “above”, “below”, “left”, “right”, “front”, “rear”, etc., are only directions referring in the accompanying drawings. Therefore, the directional terms are used to illustrate rather than limit the invention. In addition, in the following embodiments, the same or similar elements will be labeled with the same or similar numbers.

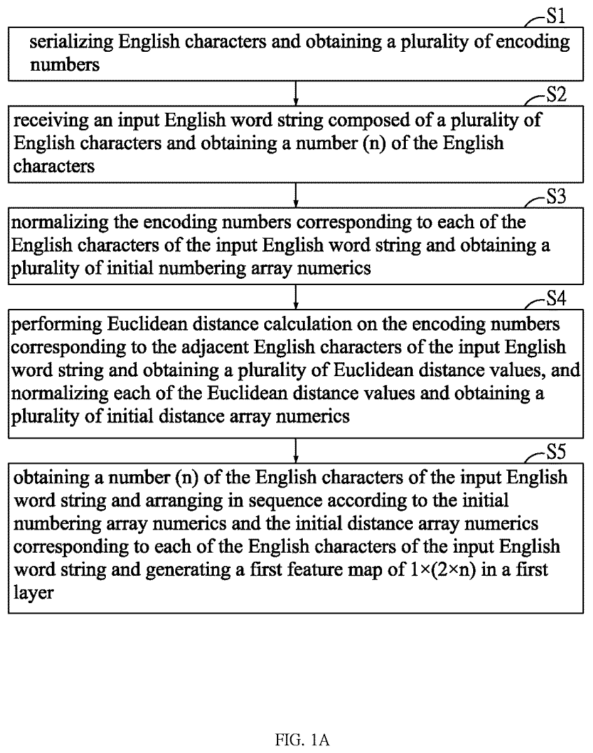

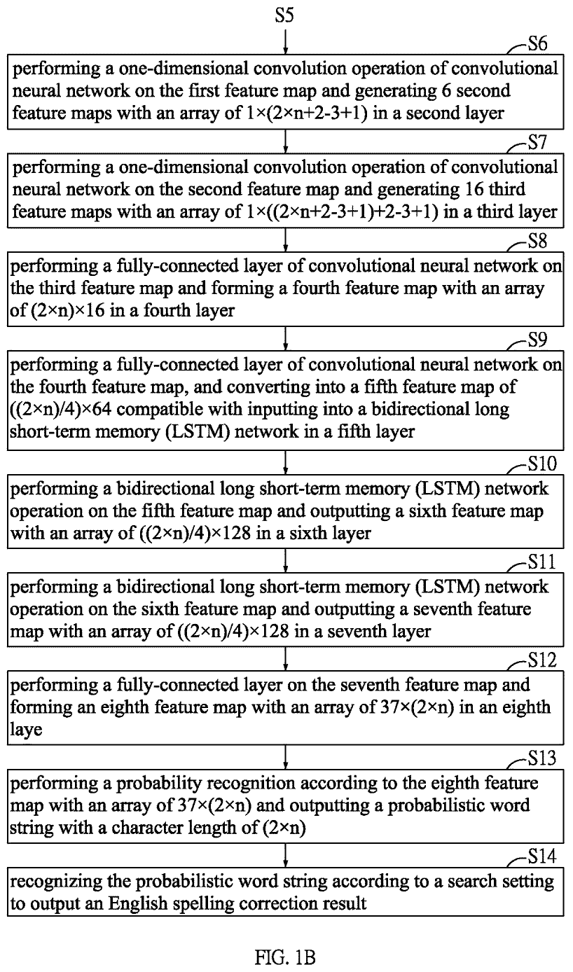

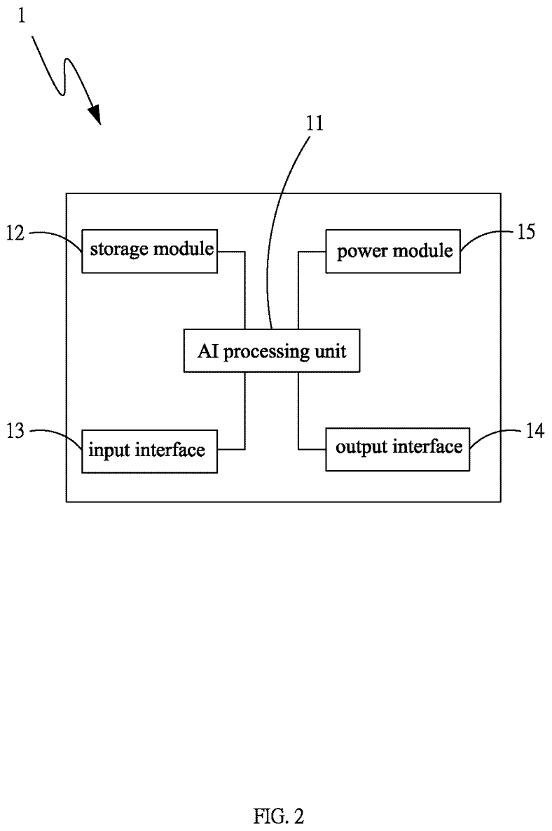

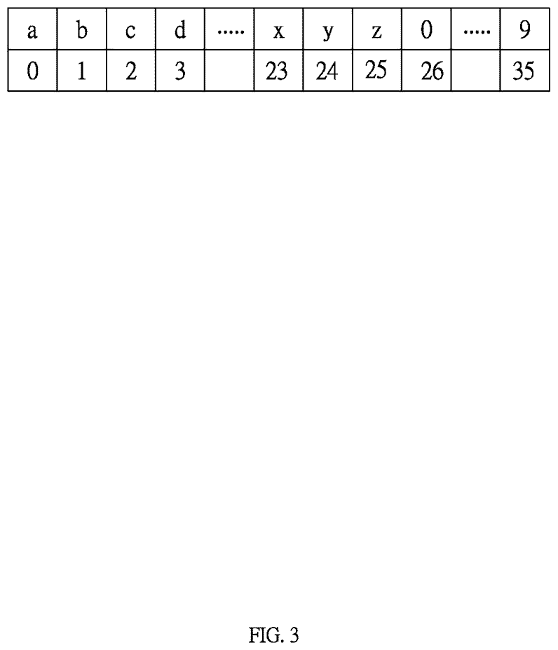

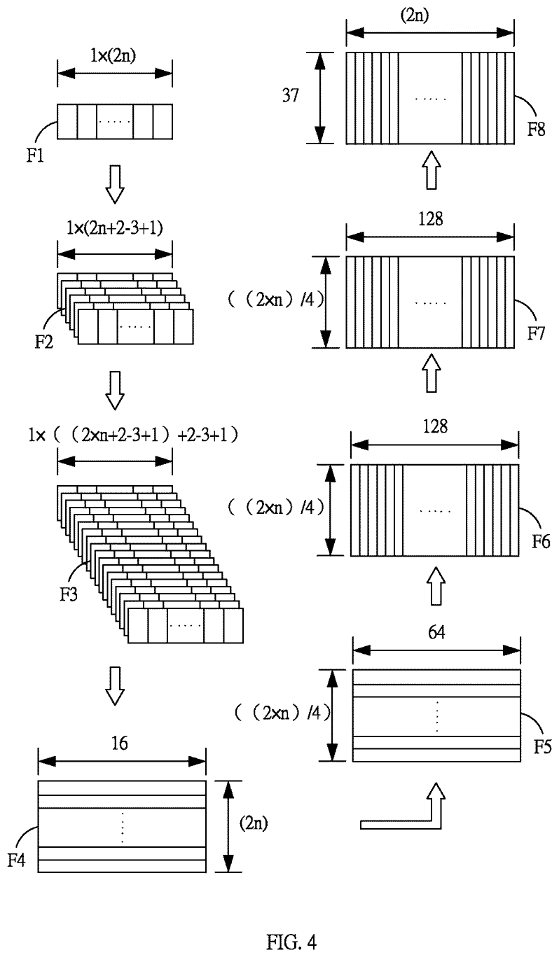

Please refer to FIG. 1A, FIG. 1B, and FIG. 2 for a partial flow chart 1 and a partial flow chart 2 of an English spelling correction method of the invention, and a schematic diagram of hardware architecture of an electronic device of the invention respectively. Wherein the English spelling correction method of the invention is mainly applied to electronic devices with computing capabilities, such as desktop computers, notebooks, mobile phones, or tablets. An electronic device 1 of the invention comprises an AI processing unit 11, a storage module 12, an input interface 13, an output interface 14 and a power module 15, wherein the AI processing unit 11 is electrically connected to the storage module 12, the input interface 13, the output interface 14 and the power module 15, and the AI processing unit 11 is an AI module that has been trained and can be used, wherein the storage module 12 is used for storing English character spellings, the input interface 13 is used for inputting English characters, the output interface 14 is used for outputting and displaying English correction results, and the power module 15 is used for providing operating power for the AI processing unit 11, the storage module 12, the input interface 13 and the output interface 14. The English spelling correction method is as follows, as shown in FIGS. 3 and 4.

Step S1: serializing English characters and obtaining a plurality of encoding numbers; wherein the AI processing unit 11 first serializes all the English characters and converts all the English characters into serial codes to obtain the encoding numbers corresponding to each of the English characters. For example, as shown in FIG. 3, the encoding number of the English character a is 0, the encoding number of the English character b is 1, the encoding number of the English character c is 2, the encoding number of the English character d is 3, the encoding number of the English character e is 4, the encoding number of the English character x is 23, the encoding number of the English character y is 24, and so on. The encoding numbers can be set in a sequential mode or in a garbled mode. In this embodiment, in addition to serializing all the English characters, the AI processing unit 11 further serializes unit digits, converting all the unit digits into serial codes to obtain encoding numbers corresponding to each of the unit digits. For example, the encoding number of the unit digit 0 is 26, the encoding number of the unit digit 1 is 27, the encoding number of the unit digit 9 is 35, and so on. The encoding numbers can be set in a sequential mode or in a garbled mode. After the AI processing unit 11 completes encoding of the English characters and the unit digits and obtains the encoding numbers, the encoding numbers are arranged in a grid in a one-dimensional space.

Step S2: receiving an input English word string composed of a plurality of English characters and obtaining a number (n) of the English characters; wherein after the AI processing unit 11 completes encoding of the English characters and the unit digits and obtains the encoding numbers, the AI processing unit 11 receives an input English word string composed of a plurality of English characters input by the input interface 13. In this embodiment, the input English word string “happy” is intended to be input, but the input English word string “heppy” is input instead. After receiving the input English word string “heppy”, the AI processing unit 11 first obtains a number (n) of the English characters of the input English word string.

Step S3: normalizing the encoding numbers corresponding to each of the English characters of the input English word string and obtaining a plurality of initial numbering array numerics; wherein after the AI processing unit 11 obtains a number (n) of the English characters, the AI processing unit 11 further normalizes the encoding numbers corresponding to each of the English characters of the input English word string, the normalization is to divide each of the encoding numbers by 36, and a numerical value of the encoding number divided by 36 is the initial numbering array numeric. For example, the encoding number of the English character “h” is 7, and the normalization of the English character “h” is 7/36, so the initial numbering array numeric obtained by the English character “h” is 0.1944. . . , in addition, the encoding number of the English character “e” is 4, and the normalization of the English character “e” is 4/36, so the initial numbering array numeric obtained by the English character “e” is 0.1111. . . , and so on. The AI processing unit 11 normalizes the encoding numbers corresponding to each of the English characters of the input English word string “heppy”, and the normalization is to divide each of the encoding numbers by 36 to obtain the initial numbering array numerics.

Step S4: performing Euclidean distance calculation on the encoding numbers corresponding to the adjacent English characters of the input English word string and obtaining a plurality of Euclidean distance values, and normalizing each of the Euclidean distance values and obtaining a plurality of initial distance array numerics; wherein after the AI processing unit 11 obtains the initial numbering array numerics, the AI processing unit 11 performs Euclidean distance calculation on the encoding numbers corresponding to the adjacent English characters of the input English word string, and a formula of the Euclidean distance value is d(X₁,X₂)=\sqrt{(X₁−X₂)²}, for example, the encoding number of the English character “h” is 7, and there is no English character in front of the English character “h”, so the English character “h” is applied with an Euclidean distance value d(0,h)=\sqrt{(0−7)²}, so the Euclidean distance value d(0,h) of the English character “h” is 7, and the encoding number of the English character “e” is 4, so a distance between the English character “h” and the English character “e” is applied with an Euclidean distance value d(h, e)=\sqrt{(7−4)²}, and the Euclidean distance value d(h, e) between the English character “h” and the English character “e” can be calculated to be 3. The encoding number of the English character “p” is 15, so a distance between the English character “e” and the English character “p” is applied with an Euclidean distance value d(e, p)=\sqrt{(4−15)²}, and the Euclidean distance value d(e, p) between the English character “e” and the English character “p” can be calculated to be 11, and so on. The AI processing unit 11 first

calculates the Euclidean distance values between the adjacent English characters, the AI processing unit 11 then normalizes each of the Euclidean distance values. The normalizations is to divide each of the encoding numbers by 36, and a numerical value of the encoding number divided by 36 is the initial distance array numeric. For example, the normalization of the Euclidean distance value d(h, e) is 3/36, so the initial distance array numeric obtained by the Euclidean distance value d(h, e) is 0.0833. . ., and the normalization of the Euclidean distance value d(h, e) is 11/36, and so on. The AI processing unit 11 normalizes each of the Euclidean distance values corresponding to the input English word string “heppy”. The normalizations is to divide each of the encoding numbers by 36 to obtain the initial distance array numerics.

Step S5: obtaining a number (n) of the English characters of the input English word string and arranging in sequence according to the initial numbering array numerics and the initial distance array numerics corresponding to each of the English characters of the input English word string and generating a first feature map of 1×(2×n) in a first layer; wherein after the AI processing unit 11 obtains the initial numbering array numerics and the initial distance array numerics, the AI processing unit 11 first obtains a number (n) of the English characters of the input English word string, and defines twice a number (n) of the English characters as an obtained character feature number, and after obtaining the character feature number, the AI processing unit 11 generates the first feature map of 1×(2×n) in the first layer of convolution neural network, and the first feature map is generated by arranging in sequence according to the initial numbering array numerics and the initial distance array numerics corresponding to each of the English characters of the input English word string. The sequential arrangement method is to arrange each of the initial numbering array numerics of each of the English characters of “heppy” in sequence, that is, numerical values after 7/36, 4/36, 15/36, 15/36, and 24/36 in sequence, and the Euclidean distance values of each of the English characters of “heppy” are arranged in sequence, that is, numerical values after \sqrt{(0−7)²}/36, \sqrt{(7−4)²}/36, \sqrt{(4−15)²}/36, \sqrt{(15−15)²}/36, and \sqrt{(15−24)²}/36 in sequence. The above sequentially arranged numerical values generate the first feature map of 1×(2×n) in the first layer.

Step S6: performing a one-dimensional convolution operation of convolutional neural network on the first feature map and generating 6 second feature maps with an array of 1×(2×n+2−3+1) in a second layer; wherein after the first feature map of 1×(2×n) is generated, the AI processing unit 11 reads a first feature map F1 of 1×(2×n), and the AI processing unit 11 performs a one-dimensional convolution operation of convolutional neural network (CNN) on the first feature map F1 of 1×(2×n), and the AI processing unit 11 performs 6 one-dimensional convolution operations with a kernel of random values and an array of 1×3, after the operation is completed, 6 second feature maps F2 with an array of 1×(2×n+2−3+1) are generated in the second layer of convolutional neural network. In this embodiment, a number (n) of the English characters of “heppy” is 5, so the second feature map F2 is 1×(2×5+2−3+1).

Step S7: performing a one-dimensional convolution operation of convolutional neural network on the second feature map and generating 16 third feature maps with an array of 1×((2×n+2−3+1)+2−3+1) in a third layer; wherein after the 6 second feature maps F2 with an array of 1×(2×n+2−3+1) are generated, the AI processing unit 11 reads the 6 second feature maps F2 with an array of 1×(2×n+2−3+1), the AI processing unit 11 performs a one-dimensional convolution operation of convolutional neural network on the 6 second feature maps F2 with an array of 1×(2×n+2−3+1), and the AI processing unit 11 performs 16 one-dimensional convolution operations with a kernel of random values and an array of 1×3. After the operations are completed, 16 third feature maps F3 with an array of 1×((2×n+2−3+1)+2−3+1) are generated in the third layer of convolutional neural network. In this embodiment, a number (n) of the English characters of “heppy” is 5, so the third feature map F3 is 1×((2×5+2−3+1)+2−3+1).

Wherein when the first feature map is performed with a one-dimensional convolution operation of convolutional neural network, two blank features are added to form the second feature map of 1×(2×n+2−3+1), and when the second feature map is performed with a one-dimensional convolution operation of convolutional neural network, the two blank features are added to form the third feature map of 1×((2×n+2−3+1)+2−3+1), wherein “+2” represents addition of the blank features, which is mainly to avoid shortening due to the convolution operation, so the blank feature is added at a beginning and an end of the array respectively. In addition, when the second and third feature maps are performed with a one-dimensional convolution operation, “−3+1” will be generated due to their 1×3 kernel convolution operation.

Step S8: performing a fully-connected layer of convolutional neural network on the third feature map and forming a fourth feature map with an array of (2×n)×16 in a fourth layer; wherein after 16 third feature maps F3 with an array of 1×((2×n+2−3+1)+2−3+1) are generated, the AI processing unit 11 further performs a fully-connected layer on the 16 third feature maps F3 with an array of 1×((2×n+2−3+1)+2−3+1), so the AI processing unit 11 generates a fourth feature map F4 with an array of (2×n)×16 in the fourth layer of convolutional neural network. In this embodiment, a number (n) of the English characters of “heppy” is 5, so the fourth feature map F4 is (2×5)×16.

Step S9: performing a fully-connected layer of convolutional neural network on the fourth feature map, and converting into a fifth feature map of ((2×n)/4)×64 compatible with inputting into a bidirectional long short-term memory (LSTM) network in a fifth layer; wherein after the fourth feature map F4 with an array of (2×n)×16 is generated, the AI processing unit 11 performs a fully-connected layer on the fourth feature map F4, and converts the fourth feature map F4 into a fifth feature map F5 of ((2×n)/4)×64 compatible with inputting into a bidirectional long short-term memory (LSTM) network in the fifth layer of convolutional neural network. In this embodiment, a number (n) of the English characters of “heppy” is 5, so the fifth feature map F5 is ((2×5)/4)×64.

Step S10: performing a bidirectional long short-term memory (LSTM) network operation on the fifth feature map and outputting a sixth feature map with an array of ((2×n)/4)×128 in a sixth layer; wherein after the fifth feature map F5 with an array of ((2×n)/4)×64 is generated, the AI processing unit 11 performs a bidirectional long short-term memory (LSTM) network operation on the fifth feature map F5 and outputs a sixth feature map F6 with an array of ((2×n)/4)×128 in the sixth layer of convolutional neural network. In this embodiment, a number (n) of the English characters of “heppy” is 5, so the sixth feature map F6 is ((2×5)/4)×128.

Step S11: performing a bidirectional long short-term memory (LSTM) network operation on the sixth feature map and outputting a seventh feature map with an array of ((2×n)/4)×128 in a seventh layer; wherein after the sixth feature map F6 with an array of ((2×n)/4)×128 is generated, the AI processing unit 11 performs a bidirectional long short-term memory (LSTM) network operation on the sixth feature map F6 and outputs a seventh feature map F7 with an array of ((2×n)/4)×128 in the seventh layer of convolutional neural network. In this embodiment, a number (n) of the English characters of “heppy” is 5, so the seventh feature map F7 is ((2×5)/4)×128.

Step S12: performing a fully-connected layer on the seventh feature map and forming an eighth feature map with an array of 37×(2×n) in an eighth layer; wherein after the seventh feature map F7 with an array of ((2×n)/4)×128 is generated, the AI processing unit 11 further performs a fully-connected layer on the seventh feature map F7 with an array of ((2×n)/4)×128, so the AI processing unit 11 generates an eighth feature map F8 with an array of 37×(2×n) in the eighth layer of convolutional neural network. In this embodiment, a number (n) of the English characters of “heppy” is 5, so the eighth feature map F8 is 37×(2×5).

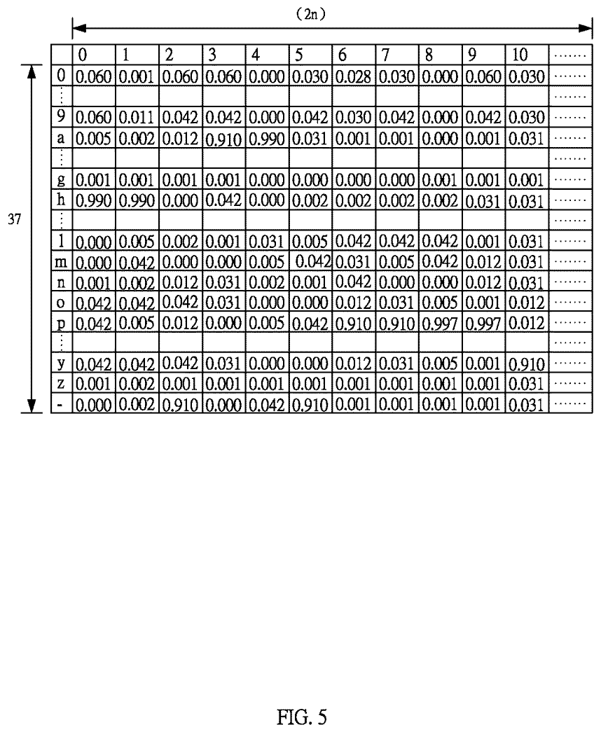

Step S13: performing a probability recognition according to the eighth feature map with an array of 37×(2×n) and outputting a probabilistic word string with a character length of (2×n); wherein after the eighth feature map F8 with an array of 37×(2×n) is generated, the AI processing unit 11 uses a greedy algorithm to define 37 categories of the eighth feature map F8 and arranges in a sequence of 0 to 2n−1, as shown in FIG. 5, which is a diagram of a probability vector table for probability calculation using the greedy algorithm, and the definition method is that categories 0-9 represent numbers 0 to 9, categories 10-35 represent the English characters a to z, and the 36th category is a blank (_), but the category definition method is not limited thereto. After the categories are defined, the AI processing unit 11 performs a greedy algorithm on numerical values in the eighth feature map F8, and then performs a probability recognition on the eighth feature map F8 to output a probabilistic word string, as shown in FIG. 5, the AI processing unit 11 recognizes and captures a probability of each coordinate position, mainly recognizing positions with probabilities close to 1, such as a probability of h in position (0) is 0.990, a probability of a is 0.005, a probability of g is 0.005, a probability of l is 0.000, a probability of m is 0.000, and a probability of n is 0.001, so the AI processing unit 11 captures h; or a probability of h in position (1) is 0.990, a probability of a is 0.002, a probability of g is 0.001, a probability of l is 0.005, a probability of m is 0.042, and a probability of n is 0.002, so the AI processing unit 11 captures h; or a probability of a in position (2) is 0.012, a probability of g is 0.001, a probability of h is 0.000, a probability of l is 0.002, a probability of m is 0.000, a probability of n is 0.012, and a probability of a blank (_) is 0.910, so the AI processing unit 11 captures the blank (_), and so on. The AI processing unit 11 uses the greedy algorithm to capture probabilities of (2×n) positions and outputs a probabilistic word string with a character length of (2×n). In this embodiment, the AI processing unit 11 is implemented by capturing hh_aa_ppppy, that is, the AI processing unit 11 generates a probabilistic word string of hh_aa_ppppy.

Step S14: recognizing the probabilistic word string according to a search setting to output an English spelling correction result; wherein after the AI processing unit 11 generates the probabilistic word string, the AI processing unit 11 recognizes the probabilistic word string according to the search setting. In this embodiment, the search setting comprises a blank character setting and a repeated character setting, wherein the blank character setting is a blank (_), and the repeated character setting is that the AI processing unit 11 recognizes the probabilistic word string and removes characters and a number of repeated words. In this embodiment, repeated characters with a maximum number are repeated 2 times, so the processing unit defines 2 times as a removal variable, and then rescans the probabilistic word string, and a character that appears for the first time is defined as a comparison character. In this embodiment, the processing unit 11 recognizes the character that appears for the first time as “h”, and the AI processing unit 11 outputs “h” and defines “h” as a comparison character, and then scans the probabilistic word string again. The AI processing unit 11 recognizes the second character as “h”, which is the same as the comparison character and meets the removal variable, so the processing unit 11 removes the second character “h”.

Then the probabilistic word string is rescanned, and the AI processing unit 11 recognizes the third character as “_”, and removes it according to the blank character setting. The AI processing unit 11 rescans the probabilistic word string, and the AI processing unit 11 recognizes the fourth character as “a”, and outputs “a” and defines “a” as the comparison character, and scans the probabilistic word string again. The AI processing unit 11 recognizes the fifth character as “a”, which is the same as the comparison character and meets the removal variable, so the AI processing unit 11 removes the fifth character “a”. The AI processing unit 11 rescans the probabilistic word string, and the AI processing unit 11 recognizes the sixth character as “_”, and removes “_” according to the blank character setting. The AI processing unit 11 rescans the probabilistic word string, and the AI processing unit 11 recognizes the seventh character as “p”, and outputs “p” and defines “p” as the comparison character, and scan the probabilistic word string again. The AI processing unit 11 recognizes the eighth character as “p”, which is the same as the comparison character and meets the removal variable, so the AI processing unit 11 removes the eighth character “p”, and the AI processing unit 11 rescans the probabilistic word string. The AI processing unit 11 recognizes the ninth character as “p”, outputs “p” and defines “p” as the comparison character, and scans the probabilistic word string again. The AI processing unit 11 recognizes the tenth character as “p”, which is the same as the comparison character and meets the removal variable, so the AI processing unit 11 removes the tenth character “p”, and the AI processing unit 11 rescans the probabilistic word string. The AI processing unit 11 recognizes the eleventh character as “y”, outputs “y” and defines “y” as the comparison character, so the AI processing unit 11 outputs an English spelling correction result of happy.

Wherein the AI processing unit 11 performs the aforementioned procedures for each input English word string, and the AI processing unit 11 generates the English spelling correction result for the initial numbering array numeric and the initial distance array numeric of the input English word string. Thus, the English spelling correction method of the invention is capable of solving the problem of missing characters or extra characters in the prior art, thereby achieving an efficacy of accurately correcting English spelling by utilizing character sequence relationship, character distance and variable array length.

Wherein the AI processing unit 11 serializes all the English characters and converts all the unit digits into serial codes. This is mainly because wrong judgement can be avoided. In an English word string input through the input interface 13 and received by the AI processing unit 11, the English spelling correction method of the invention is capable of automatically correcting any incorrectness if the input English word string is incorrect and mixed with the unit digits. For example, if a unit digit 0 is input, it can be avoided from being judged as the English character O; or if a unit digit 2 is input, it can be avoided from being judged as the English character Z; or if a unit digit 1 is input, it can be avoided from being judged as the English character I or L. Thereby, in addition to the English spelling correction method of the invention being capable of solving the problem of missing characters or extra characters in the prior art, further capable of achieving an efficacy of accurately correcting English spelling when an input English word string is incorrect and mixed with the unit digits.

The invention has been described in detail above, but the above description merely illustrates a preferred embodiment of the invention, and should not be used to limit a scope implemented by the invention, that is, all equivalent changes and modifications made according to the applied scope of the invention should still fall within the scope covered by the appended claims of the invention.

What is claimed is:

1. An English spelling correction method, applied to an electronic device with computing capabilities, the electronic device comprising an AI processing unit, the English spelling correction method at least comprising:
serializing English characters and obtaining a plurality of encoding numbers;
receiving an input English word string composed of a plurality of English characters and obtaining a number (n) of the English characters;
normalizing the encoding numbers corresponding to each of the English characters of the input English word string and obtaining a plurality of initial numbering array numerics;
performing Euclidean distance calculation on the encoding numbers corresponding to the adjacent English characters of the input English word string and obtaining a plurality of Euclidean distance values, and normalizing each of the Euclidean distance values and obtaining a plurality of initial distance array numerics;
obtaining a number (n) of the English characters of the input English word string and arranging in sequence according to the initial numbering array numerics and the initial distance array numerics corresponding to each of the English characters of the input English word string and generating a first feature map of 1×(2×n) in a first layer;
performing a one-dimensional convolution operation of convolutional neural network on the first feature map and generating 6 second feature maps with an array of 1×(2×n+2−3+1) in a second layer;
performing a one-dimensional convolution operation of convolutional neural network on the second feature map and generating 16 third feature maps with an array of 1×((2×n+2−3+1)+2−3+1) in a third layer;
performing a fully-connected layer of convolutional neural network on the third feature map and forming a fourth feature map with an array of (2×n)×16 in a fourth layer;
performing a fully-connected layer of convolutional neural network on the fourth feature map, converting into a fifth feature map of ((2×n)/4)×64 compatible with inputting into a bidirectional long short-term memory (LSTM) network in a fifth layer;
performing a bidirectional long short-term memory (LSTM) network operation on the fifth feature map and outputting a sixth feature map with an array of ((2×n)/4)×128 in a sixth layer;
performing a bidirectional long short-term memory (LSTM) network operation on the sixth feature map and outputting a seventh feature map with an array of ((2×n)/4)×128 in a seventh layer;
performing a fully-connected layer on the seventh feature map and forming an eighth feature map with an array of 37×(2×n) in an eighth layer;
performing a probability recognition according to the eighth feature map with an array of 37×(2×n) and outputting a probabilistic word string with a character length of (2×n); and
recognizing the probabilistic word string according to a search setting to output an English spelling correction result.

2. The English spelling correction method as claimed in claim 1, wherein the AI processing unit serializes the English characters and unit digits and obtains the encoding numbers, and wherein the AI processing unit serializes the English characters from A to Z and the unit digits from 0 to 9 and obtains the encoding numbers of each of the English characters and the unit digits.

3. The English spelling correction method as claimed in claim 2, wherein in the step of the AI processing unit normalizing the encoding numbers corresponding to each of the English characters of the input English word string and obtaining the initial numbering array numerics, the normalization is to divide each of the encoding numbers by 36 to obtain the initial numbering array numerics.

4. The English spelling correction method as claimed in claim 1, wherein in the step of the AI processing unit performing Euclidean distance calculation on the encoding numbers corresponding to the adjacent English characters of the input English word string and obtaining a plurality of Euclidean distance values, and normalizing each of the Euclidean distance values and obtaining a plurality of initial distance array numerics, the normalization is to divide each of the Euclidean distance values by 36 to obtain the initial numbering array numerics.

5. The English spelling correction method as claimed in claim 1, wherein a formula of the Euclidean distance value is d(X₁,X₂)=\sqrt{(X₁−X₂)²}.

6. The English spelling correction method as claimed in claim 1, wherein the AI processing unit performs 6 one-dimensional convolution operations of convolutional neural network with a kernel of random values and a 1×3 array to generate the 6 second feature maps with an array of 1×(2×n+2−3+1) in the second layer.

7. The English spelling correction method as claimed in claim 6, wherein the AI processing unit performs 16 one-dimensional convolution operations of convolutional neural network with a kernel of random values and a 1×3 array to generate the 16 third feature maps with an array of 1×((2×n+2−3+1)+2−3+1) in the third layer.

8. The English spelling correction method as claimed in claim 7, wherein when the first feature map is performed with the one-dimensional convolution operation of convolutional neural network, a blank feature is added at a beginning and an end of the array respectively to form the second feature map of 1×(2×n+2−3+1), and when the second feature map is performed with the one-dimensional convolution operation of convolutional neural network, a blank feature is added at a beginning and an end of the array respectively to form the third feature map of 1×((2×n+2−3+1)+2−3+1).

9. The English spelling correction method as claimed in claim 1, wherein the search setting comprises a blank character setting and a repeated character setting, and the AI processing unit recognizes the probabilistic word string, and removes the blank character setting and the repeated character setting to output an English word string recognition result.
